(19) United States
(12) Patent Application Publication
(10) Pub. No.: US 2010/0209746 A1
(43) Pub. Date: Aug. 19, 2010

(54) SEALED BATTERY

(76) Inventor: Akira Kiyama, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/681,894

(22) PCT Filed: Oct. 7, 2008
(86) PCT No.: PCT/JP2008/002832

§ 371 Date: Apr. 7, 2010

(30) Foreign Application Priority Data
Oct. 12, 2007 (JP) 2007-267248

(51) Int. Cl. H01M 2/12

(52) U.S. Cl. 429/56

(57) ABSTRACT

A sealed battery (100) provided in the present invention includes an electrode assembly (80), an outer case (40) housing the electrode assembly (80), a sealing lid (20) for closing an opening (42) of the outer case (40), and a current cutoff valve (22) that is deformed by abnormal internal pressure in the outer case (40). A plurality of conductive members (10) for carrying current between the current cutoff valve (22) and electrode assembly (80) are attached to the current cutoff valve (22). The plurality of conductive members (10) are configured so as to be broken off in a stepwise manner by the deformation of the current cutoff valve (22) as a result of abnormal internal pressure, thereby shutting off current flowing between the current cutoff valve (22) and electrode assembly (80).

### TECHNICAL FIELD

The present invention relates to a sealed battery, and in particular to a sealed battery equipped with a current cutoff valve.

This application also claims priority right based on Japanese Patent Application 2007-267248 filed on Oct. 12, 2007, the contents of which are hereby incorporated by reference.

### BACKGROUND

Recently there has been increasing demand for lithium ion batteries, nickel-hydrogen batteries, and other types of secondary batteries (storage batteries) as on-board power sources in vehicles or power sources for personal computers and portable terminals. Light-weight lithium ion batteries that provide high energy density are particularly promising as batteries suitable for use as on-board high-output power sources. Batteries with a sealed structure (sealed batteries) comprising a sealed case housing an electrode assembly and an electrolyte are a typical structure of such secondary batteries.

However, in the event of malfunctions caused by charger failure or battery defects when this type of battery is charged, greater current than usual may end up being supplied to the battery, resulting in overcharging. When battery abnormalities such as this type of overcharging occur, the internal pressure of the sealed battery case may increase as a result of gas produced in the interior, and the battery may rupture or catch fire. A battery structure equipped with a current cutoff valve for shutting off the current and releasing the internal pressure has been proposed as a conventional technique for dealing with such battery abnormalities.

Patent Citation 1 below, for example, discloses a sealed storage battery equipped with a current cutoff valve that is connected to electrode assembly connectors via breakable metal foil that is broken a result of abnormal internal pressure. This sealed storage battery is designed in such a way that the breakable metal foil is broken by the action of the abnormal pressure in the current cutoff valve, and the current cutoff valve becomes detached from the connector, shutting off the current. Patent Citation 2 describes an example of the structure of a current cutoff valve in a similar technique.

[Patent Citation 1] JP-A 10-241653

[Patent Citation 2] JP-A 2005-108503

### DISCLOSURE OF THE INVENTION

However, the technique in Patent Citation 1 makes it difficult to provide current allowing large current (such as large current over 4A) to be discharged. More specifically, the discharge of large current necessitates increasing the thickness (cross section area) of the breakable metal foil that functions as the current-carrying component, but when the thickness (cross section area) of the breakable metal foil is increased, that much more force (and by extension, the internal force of the case in which the current cutoff valve operates) is needed to break the metal foil. Thus, in the interests of preventing the cutoff performance of the current cutoff valve from being compromised, it has been necessary to reduce the thickness (cross section area) of the breakable metal foil to control current discharge to a certain extent.

The battery provided by the invention is a sealed battery. This type of sealed battery has an electrode assembly, an outer case for housing the electrode assembly, a sealing lid for closing an opening of the outer case, and a current cutoff valve that is deformed by abnormal internal pressure in the outer case. A plurality of conductive members (such as leads) for carrying current between the current cutoff valve and electrode assembly are attached to the current cutoff valve. The plurality of conductive members are configured so as to be broken off in a stepwise manner by the deformation of the current cutoff valve as a result of abnormal internal pressure, thereby shutting off the current flowing between the current cutoff valve and electrode assembly.

Because a plurality of conductive members are used to carry current between the current cutoff valve and electrode assembly in the battery having this structure, the electrical resistance can be lower than when one conductive member (such as one lead) is used, allowing large current (such as current over 4A) to flow. Furthermore, the plurality of conductive members is broken off in a stepwise manner (that is, the conductive members are sequentially broken off one at a time or several at a time) when abnormal internal pressure develops in the outer case during battery abnormalities. Rather than having the plurality of conductive members collectively broken off at the same time, the force required to break the members can therefore be distributed at staggered times (at different times) to ensure that current is shut off when the internal pressure is abnormal.

That is, the structure of the invention makes it possible to provide a sealed battery (typically a secondary battery) that is capable of outputting large current during normal operation while preventing the cutoff function of the current cutoff valve from being compromised. The invention therefore can provide a sealed battery that is suitable in particular for on-board use in vehicles requiring the discharge of large current.

A preferred embodiment is a sealed battery in which the current cutoff valve is provided in the sealing lid. Providing the current cutoff valve in the sealing lid means that a sealed battery endowed with the above effects can be provided without the need for providing new special members or the like for setting up the current cutoff valve (that is, without the need for making the battery case structure more complex).

In a preferred embodiment of the battery disclosed herein, the plurality of conductive members (leads) are attached, with a predetermined loosening margin, to one or more connecting points on the above current cutoff valve. The one or more connecting points are configured to shift in a direction to extend the loosening margin of the conductive members by the deformation of the current cutoff valve, and the plurality of conductive members are sequentially broken off at different points in time respectively as the connecting points shift.

In this structure, the loosening margin (loosening amount) is varied for each of the plurality of conductive members (such as foil leads), or the plurality of conductive members are attached to connecting points with different deforming (shifting) timing, allowing the timing by which the conductive members are broken off to be easily staggered. It is thus possible to provide a battery capable of outputting large current with an extremely simple battery structure. The force required to break each conductive member (and by extension, the pressure in the case in which the current cutoff valve operates) can also be adjusted depending on the conductive member (lead) material, thickness, or the like.

In the preferred embodiments of the battery disclosed here, the plurality of conductive members (such as foil leads) may be attached, with varying loosening margins, to the same connecting point on the current cutoff valve.

The loosening margin (loosening amount) of the conductive members can be varied in this way to readily stagger the timing by which the conductive members are broken off. The conductive members can also be collectively attached to the same connecting point (by means of welding, for example) to simplify the work involved in attaching the conductive members, thereby efficiently building a sealed battery.

In another preferred embodiment of the battery disclosed herein, the plurality of conductive members are attached, with the same loosening margin, to different connecting points on the current cutoff valve.

In this embodiment, the conductive members are attached to connecting points with different deforming (shifting with the deformation of the current cutoff valve) timing. This allows the points in time (timing) at which the conductive members (such as foil leads) are broken off to be easily and reliably staggered. In the above structure, the conductive members are also attached to different connecting points on the current cutoff valve, allowing heat produced in the current cutoff valve during the supply of current to be dispersed. It is thus possible to provide a thermally stable, high-performance sealed battery (typically a secondary battery).

### BRIEF DESCRIPTION OF THE DRAWINGS

FIG. 1A is a sectional view schematically illustrating the main elements of a battery during ordinary internal pressure in an embodiment of the invention;

FIG. 1B is a sectional view schematically illustrating the main elements of a battery when the internal pressure increases in an embodiment of the invention;

FIG. 2A is a sectional view for illustrating the stepwise breaking mechanism of conductive foil in an embodiment of the invention;

FIG. 2B is a sectional view for illustrating the stepwise breaking mechanism of conductive foil in an embodiment of the invention;

FIG. 2C is a sectional view for illustrating the stepwise breaking mechanism of conductive foil in an embodiment of the invention;

FIG. 3A is a sectional view for illustrating the stepwise breaking mechanism of conductive foil in another embodiment of the invention;

FIG. 3B is a sectional view for illustrating the stepwise breaking mechanism of conductive foil in another embodiment of the invention;

FIG. 3C is a sectional view for illustrating the stepwise breaking mechanism of conductive foil in another embodiment of the invention;

FIG. 4A is a sectional view for illustrating the stepwise breaking mechanism of conductive foil in another embodiment of the invention;

FIG. 4B is a sectional view for illustrating the stepwise breaking mechanism of conductive foil in another embodiment of the invention;

FIG. 4C is a sectional view for illustrating the stepwise breaking mechanism of conductive foil in another embodiment of the invention;

FIG. 5A is a sectional view for illustrating the stepwise breaking mechanism of conductive foil in another embodiment of the invention;

FIG. 5B is a sectional view for illustrating the stepwise breaking mechanism of conductive foil in another embodiment of the invention;

FIG. 5C is a sectional view for illustrating the stepwise breaking mechanism of conductive foil in another embodiment of the invention;

FIG. 6A is a sectional view for illustrating the stepwise breaking mechanism of conductive foil in another embodiment of the invention;

FIG. 6B is a sectional view for illustrating the stepwise breaking mechanism of conductive foil in another embodiment of the invention;

FIG. 6C is a sectional view for illustrating the stepwise breaking mechanism of conductive foil in another embodiment of the invention; and

FIG. 7 is a side view schematically illustrating a vehicle (automobile) equipped with the battery in an embodiment of the invention.

### BEST MODE FOR CARRYING OUT THE INVENTION

Embodiments of the present invention are illustrated below with reference to the attached figures. In the figures, the same symbols are used for members and sites that have the same functions. Dimensional relationships (such as length, width, and thickness) in the figures do not reflect actual dimensional relationships. The invention is not limited to the following embodiments.

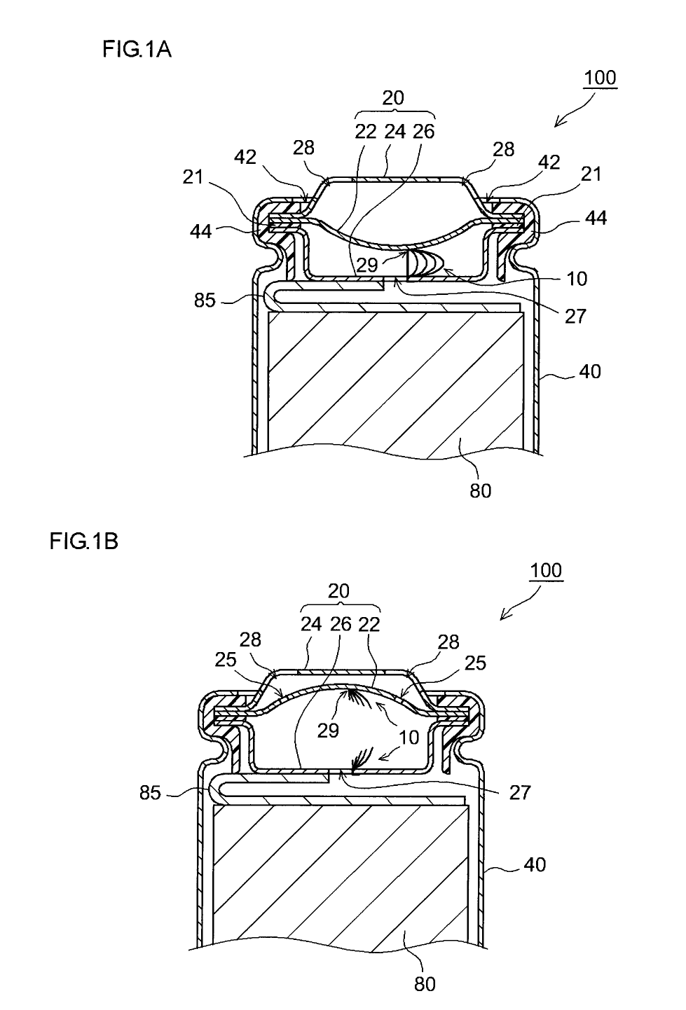

The structure of the sealed battery 100 (referred to below as “battery”) will be described with reference to FIGS. 1A and 1B. FIG. 1A illustrates the cross sectional structure of the battery 100 during normal operation (stage before the current cutoff valve 22 is actuated), and FIG. 1B illustrates the cross sectional structure of the battery 100 when the internal pressure is abnormal (when the current cutoff valve 22 is actuated).

As illustrated in FIG. 1A the battery 100 in this embodiment typically includes, in the same manner as conventional batteries, an electrode assembly 80 equipped with the prescribed battery constituents (active material for positive and negative electrodes, collectors for positive and negative electrodes, separator, etc.), an outer case 40 for housing the electrode assembly 80 and a suitable electrolyte solution, and a sealing lid 20 for closing the opening 42 of the outer case.

The outer case 40 should be a shape capable of housing the rolled electrode assembly 80 described below. In this embodiment, the outer case 40 is in the form of a bottomed cylinder, with an opening 42 formed at the top end. The material for the outer case 40 may be any that is the same as that used in conventional batteries. In this embodiment, the outer case 40 also serves as the negative electrode terminal, and the material is nickel-plated steel.

The sealing lid 20 is a member for closing the opening 42 of the outer case 40. In this embodiment, the sealing lid 20 is attached to the opening 42 of the outer case 40, with a gasket (insulating resin) 44 in between. Generally speaking, the sealing lid 20 is composed of a sealing bottom plate 26, current cutoff valve 22, and cap 24 laminated in that order, and the periphery is crimped to the outer case 40, with the gasket 44 in between. Crimping the lid with the gasket 44 in between in this manner will provide insulation between the sealing lid 20 and outer case 40, plugging the gap between the two to form the battery sealing structure.

The cap 24 is a disk-shaped member consisting of a metal material (here, aluminum). The central portion of the cap 24 protrudes out of the case (the top in the figure), forming an electrode terminal (here, the positive electrode terminal). Gas venting holes 28 are provided in the sides of the central protruding part of the cap 24.

The sealing bottom plate 26 is a generally cylindrical metal member having gas venting holes (not shown). The sealing bottom plate 26 is electrically connected to the electrode assembly 80 housed in the outer case. In this embodiment, the sealing bottom plate 26 is electrically connected by a collector plate 85 to the positive electrode of the electrode assembly 80. In the illustrated example, the collector plate 85 is bonded (such as by welding) to the bottom surface (reverse surface) of the sealing bottom plate 26. The collector plate 85 is connected to the positive electrode of the electrode assembly 80. Holes 27 for connecting the plurality of conductive members (such as foil leads) 10 described below are provided in the central portion of the sealing bottom plate 26.

The current cutoff valve 22 is a member that is held between the sealing bottom plate 26 and the cap 24 forming the electrode terminal (the positive electrode terminal in this example). The current cutoff valve 22 is designed in such a way as to become deformed by abnormal internal pressure in the outer case 40 (that is, abnormally increased internal pressure caused by gas produced inside the case). In this embodiment, as illustrated in FIG. 1A, the current cutoff valve 22 has a shape with a downwardly curved central portion, and the periphery is placed on the sealing bottom plate 26, with an insulating plate 21 in between. When abnormal internal pressure is reached inside the outer case 40, the curved central portion below the current cutoff valve 22 is pushed and deformed upward (vertical inversion), as illustrated in FIG. 1B. The central portion of the current cutoff valve 22 is designed to curve upward after becoming deformed.

Engraved marks (notches) are formed in the current cutoff valve 22. As illustrated by the symbol “25” in FIG. 1B, the engraved marks (notches) are designed to be broken by the deformation of the current cutoff valve 22 (here, vertical inversion), so that the pressure inside the case is released (the internally produced gas is released). The material of the current cutoff valve 22 should be a flexible material capable of being deformed by abnormal internal pressure inside the case. A current cutoff valve made of aluminum, for example, is suitable for use.

A plurality of conductive members (leads) 10 that carry current between the current cutoff valve 22 and electrode assembly 80 are attached to the current cutoff valve 22. In this embodiment, the plurality of conductive members 10 are attached at one end to the underside of the current cutoff valve 22, and are attached at the other end to the under side of the sealing bottom plate 26 through the small holes 27. The shape and material of the conductive members 10 should be conductive (electrically conductive) and breakable when subjected to suitable tensile force. Leads 10 in the form of aluminum foil, for example, are suitable for use (referred to below as “conductive foil”). In this embodiment, 0.1 mm thick aluminum foil is used as the conductive members 10.

Each of the plurality of conductive foil 10 components is attached, with a predetermined loosening margin, to a connecting point (connector) 29 on the current cutoff valve 22. In this embodiment, the plurality of conductive foil 10 components are collectively attached in a single bundle. More specifically, the upper ends of the conductive foil 10 are collectively bundled and then connected to the same connecting point 29 on the underside of the current cutoff valve 22. The bottom ends of the conductive foil 10 are also collectively bundled and then bonded (such as by spot welding) to the underside (reverse side) of the sealing bottom plate 26 through the small holes 27. The bonding means is spot welding, for example. Interposing the plurality of conductive foil 10 components between the current cutoff valve 22 and electrode assembly 80 in this way will preferably allow the electrical resistance to be lowered while current is being supplied, and will allow large current to be carried between the two (and by extension, the cap 24 forming the electrode terminal).

The plurality of conductive foil 10 components are also broken off in a stepwise manner by the deformation of the current cutoff valve 22, so that the current flowing between the current cutoff valve 22 and electrode assembly 80 is shut off. In this embodiment, the loosening margin of each of the plurality of conductive foil 10 components is altered, so that the timing of the breakage of the conductive foil 10 is staggered. More specifically, the plurality of conductive foil 10 components are attached, with different loosening margin, to the same connecting point 29. In the illustrated example, the loosening margin of the plurality of conductive foil 10 components is adjusted so that there is a greater loosening margin as the conductive foil components are closer to the inner wall (right side in figure) of the outer case 40.

The loosening margin of the conductive foil 10 may be adjusted by changing the length (entire length) of the conductive foil 10 that is used in accordance with the desired loosening margin. Alternatively, the loosening margin of the conductive foil 10 may be adjusted by suitably staggering the positions where the conductive foil components are joined so as to result in the desired loosening margin, using conductive foil components that are all the same length.

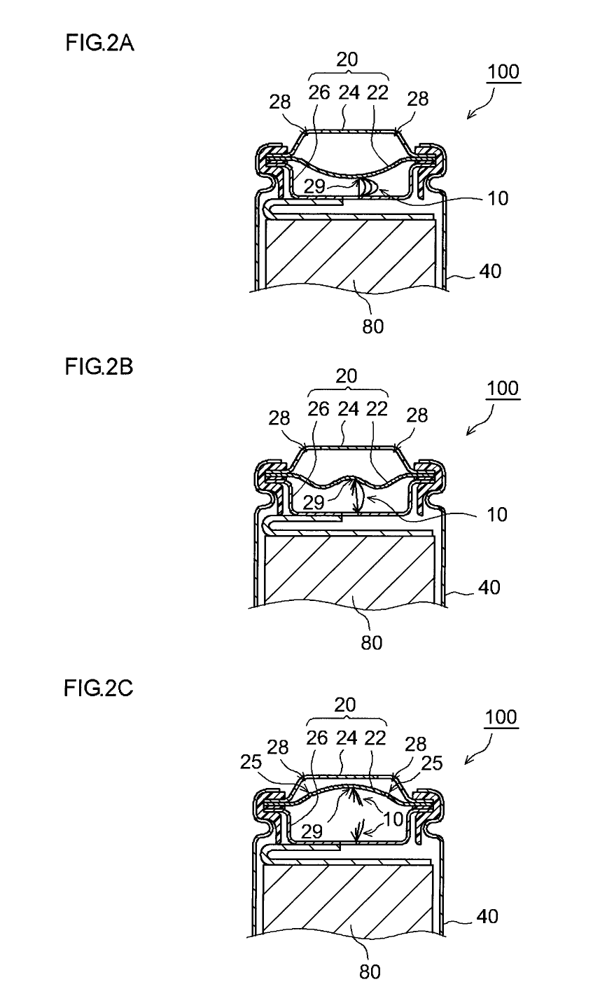

The mechanism by which the conductive foil 10 is broken off in a stepwise manner will be illustrated with reference to FIGS. 2A to 2C. As illustrated in FIG. 2A, during normal operation (the stage before the current cutoff valve 22 is actuated), the plurality of conductive foil 10 components are each attached, with different loosening margins, to the same connecting point 29 on the current cutoff valve 22.

As illustrated in FIG. 2B, when the internal pressure increases as a result of gas produced in the interior of the outer case in this state, the current cutoff valve 22 becomes deformed, and the curved central portion is gradually pushed up, during which the connecting point 29 shifts in the direction (upward in the invention) in which the loosening margin of the conductive foil 10 components is extended. The distance for which the connecting point 29 moves is longer than the loosening margin (loosening amount) established for each conductive foil 10 component. That is, as the connecting point 29 moves (upward in the figure), tension is applied to the conductive foil starting with the foil having the smallest loosening margin (conductive foil on left in the illustrated example), and the foil components are each broken off (broken vertically in the figure) in order at different points in time.

As illustrated in FIG. 2C, when the current cutoff valve 22 is completely deformed (here, vertically inverted), all of the conductive foil 10 which used to connect the current cutoff valve 22 and sealing bottom plate 26 will be broken. In this way, the plurality of conductive foil 10 components is broken off stepwise (one at a time, in this example), allowing the current flowing between the current cutoff valve 22 and electrode assembly 80 to be efficiently shut off.

Gas produced in the outer case 40 is also sequentially guided to gas venting holes (not shown) in the sealing bottom plate 26, the engraved marks 25 which are opened by the deformation of the current cutoff valve 22, and the gas venting holes 28 in the sides of the cap 24, and is then released out of the outer case 40.

Because a plurality of conductive foil 10 components are used to carry current between the current cutoff valve 22 and electrode assembly 80 in the structure of this embodiment, the electrical resistance can preferably be lower than when one conductive member (such as one lead) is used, allowing large current (such as large current over 4A) to flow.

Furthermore, the plurality of conductive foil components are broken off in a stepwise manner (are sequentially broken off one at a time in this embodiment) when abnormal internal pressure develops in the outer case during battery abnormalities. Rather than having the plurality of conductive members collectively broken off at the same time, the force required to break the members can therefore be distributed at staggered times (at different times) to ensure that current is shut off when the internal pressure is abnormal.

That is, the structure of this embodiment makes it possible to provide a sealed battery that is capable of outputting large current during normal operation while preventing the cutoff function of the current cutoff valve 22 from being compromised. The structure of this embodiment can therefore provide a sealed battery that is suitable in particular for on-board use in vehicles requiring the discharge of large current. The force required to break each strip of conductive foil (by extension, the pressure in the case in which the current cutoff valve operates) can be properly adjusted depending on the material, thickness, and the like of the conductive foil.

In this embodiment, the loosening margin (loosening amount) of the conductive foil 10 components can also be varied to allow the timing by which the conductive foil 10 components are broken to be readily and reliably staggered. Furthermore, because the conductive foil 10 components are collectively attached to the same connecting point 29 (such as by means of welding), the work involved in attaching the conductive foil 10 can be simplified to ensure that sealed batteries are more efficiently constructed.

In the above embodiment, the example was of strips of conductive foil being sequentially broken one at a time, but the invention is not limited to breaking of the conductive foil 10 strips one at a time, as long as the force required to break off the conductive foil can be distributed at staggered times to prevent the cutoff function of the current cutoff valve 22 from being compromised. The loosening margin of the conductive foil may be adjusted so that, for example, the conductive foil strips sequentially break several at a time.

The plurality of conductive foil 10 components may also be in the form of collector tabs for tab type power collecting, for example, which can be used as a power collecting method in batteries. More specifically, the plurality of conductive foil 10 components may be directly joined to the electrodes of the electrode assembly 80 (portion coated with active material in rolled electrode assembly 80) without the sealing bottom plate 26 or collector plate 85 interposed between. This structure will allow current to be directly taken from the electrode assembly 80, not through the sealing bottom plate 26 or collector plate 85, and will therefore even more effectively lower the collection resistance and control the evolution of heat in the collector.

The plurality of conductive foil components are placed between the current cutoff valve 22 and sealing bottom plate 26, and are preferably attached in such a way as to be sequentially broken off by the deformation of the current cutoff valve 22. The layout of the conductive foil can therefore be suitably modified in accordance with battery manufacturing conditions, etc.

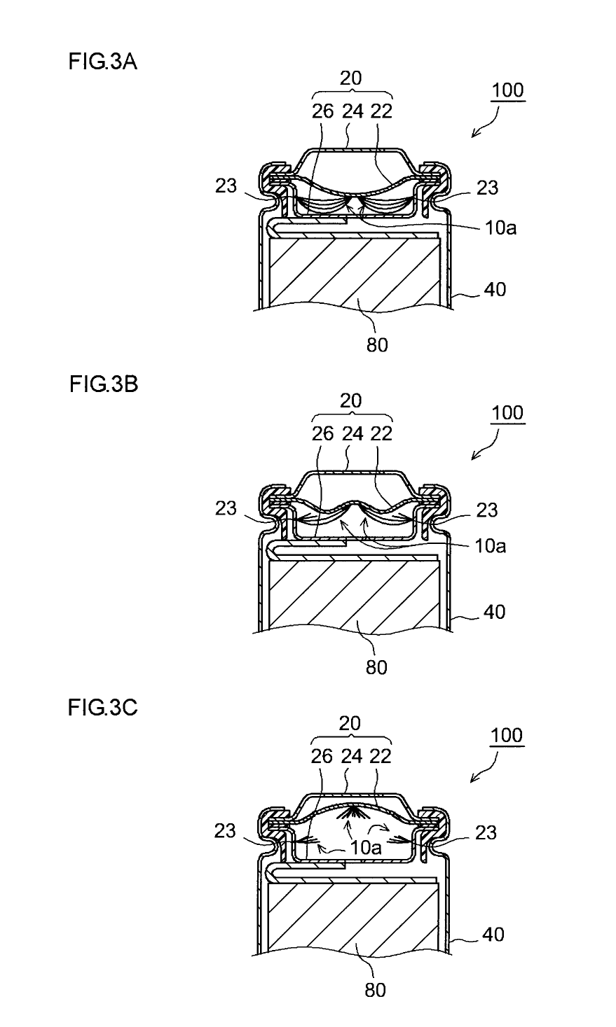

As illustrated in FIG. 3A, for example, the locations where the plurality of conductive foil components are attached may be changed from the underside to the side 23 of the sealing bottom plate 26. The loosening margin of the conductive foil 10a can be suitably adjusted, regardless of where the plurality of conductive foil components are attached, to allow the conductive foil 10a to be broken off at staggered times. In the example of FIG. 3A, the plurality of conductive foil 10a strips is attached so that the loosening margin is longer the closer the conductive foil is to the electrode assembly 80 (bottom of figure). Thus, as illustrated in FIGS. 3B and 3C, the conductive foil is sequentially broken off on the side farthest from the electrode assembly 80 (top of figure).

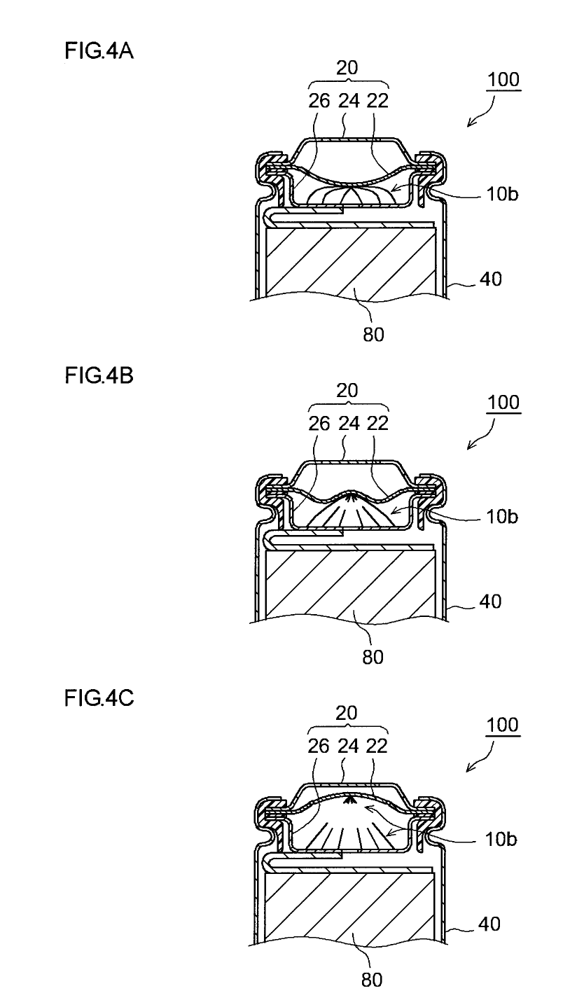

Alternatively, as illustrated in FIG. 4A, the plurality of conductive foil 10b components may be individually welded to the sealing bottom plate 26 rather than having the collectively bundled plurality of conductive foil 10b components welded to the sealing bottom plate 26. In this type of structure, the loosening margin of the conductive foil 10b components can be suitably adjusted so as to stagger the timing by which the conductive foil 10b components are broken off is appropriately staggered. In the example in FIG. 4A, the conductive foil 10b components are attached so that the loosening margin is greater the closer the conductive foil is to the inner wall of the case. Thus, as illustrated in FIGS. 4B and 4C, the foil is sequentially broken off beginning with the conductive foil farthest from the inner wall of the case.

In the above embodiment, the example was of loosening margin being varied for each strip of conductive foil so that the conductive foil 10 was sequentially broken off, but the invention is not limited to this timing for breaking of the conductive foil. For example, the plurality of conductive foil components can be distributed and attached to a plurality of connecting points (connectors) with different deforming (shifting) timing, thereby making it easier to stagger the timing by which the conductive foil is broken.

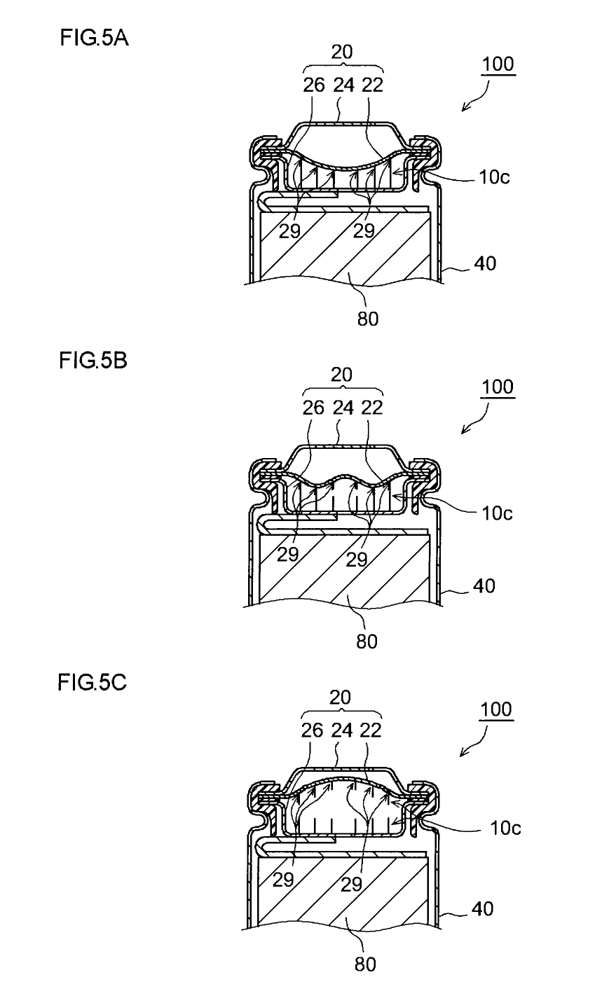

In this embodiment, as illustrated in FIG. 5A, the conductive foil 10c components are attached, with the same loosening margin, to a plurality of connecting points 29 which have a deforming timing (shifting along with the deformation of the current cutoff valve 22) that is different from each other. In this embodiment, the plurality of conductive foil 10c components is attached to a plurality of different equidistantly lined up connecting points 29. The conductive foil 10c is arranged in a row, with virtually no loosening margin (each under tension).

In this embodiment, when the internal pressure increases as a result of the gas produced inside the outer case, the current cutoff valve 22 becomes deformed and the curved central portion is gradually pushed up, as illustrated in FIG. 5B, whereupon the plurality of different connecting points 29 meanwhile shift (upward in the figure) in the direction in which the loosening margin of the conductive foil 10 components is extended.

The plurality of connecting points 29 shift at a deforming timing (shifting along with the deformation of the current cutoff valve 22) that is different from each other. In this embodiment, the connecting point that is closest to the curved central portion of the current cutoff valve 22 among the plurality of connecting points 29 will shift upward at the initial stage of the current cutoff valve 22 deformation (early timing). As a result, tension is sequentially applied, staring with the conductive foil that is attached to the connecting point 29 which moves the earliest (conductive foil near the center of the current cutoff valve 22 in the illustrated example), so that foil components are sequentially broken off at different points in time (broken vertically in the figure).

In this way, the conductive foil 10c is distributed and attached to a plurality of connecting points 29 that have different deforming timing (shifting along with the deformation of the current cutoff valve 24), allowing the points in time (timing) at which the conductive foil 10c is broken to be easily and reliably staggered.

According to this structure, heat produced in the current cutoff valve 22 while the current is being supplied can be dispersed because the conductive foil is attached to different connecting points 29 on the current cutoff valve 22. It is thus possible to provide a thermally stable high-performance sealed battery.

The attachment deforming (shifting with the deformation of the current cutoff valve) timing can be suitably adjusted depending on the shape of the current cutoff valve 22, the locations where the engraved marks are formed, and the like. A structure can also be built so that the connecting point closest to the peripheral edge of the curved portion of the current cutoff valve 22 out of the plurality of connecting points will shift at the early stage of current cutoff valve 22 deformation (early timing).

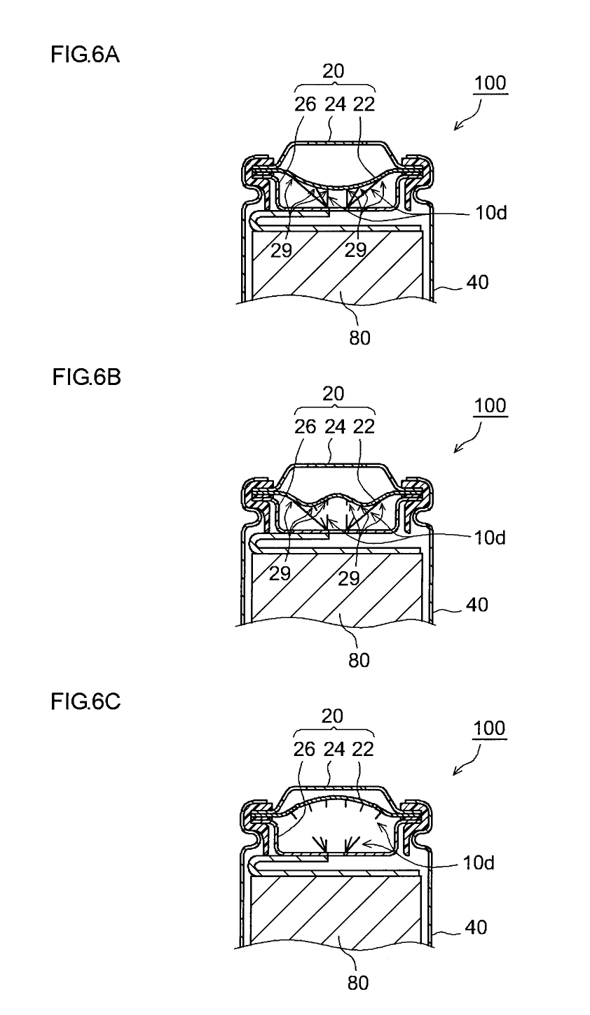

As illustrated in FIG. 6A, the conductive foil 10d components may be collectively bundled and welded to the sealing bottom plate 26 instead of having the conductive foil 10d components individually welded to the sealing bottom plate 26. In this type of structure as well, the conductive foil 10d components will be individually attached to a plurality of connecting points 29 on the current cutoff valve 22 side where the deforming (shifting) timing is different, so that, as illustrated in FIGS. 6B and 6C, the timing by which the conductive foil 10d is broken can be staggered.

The structure of the battery 100 and materials for forming the battery 100, etc., in this embodiment will be discussed in detail with reference to FIG. 1A.

The structure of the battery 100 is not particularly limited, provided that the battery 100 is a sealed battery 100 with a current cutoff valve. Secondary batteries are preferred. Nickel-hydrogen batteries and electrical double-layered capacitors (that is, physical batteries) are examples of battery structures suitable for the invention. Lithium ion secondary batteries are a particularly suitable battery structure for the invention. Lithium ion secondary batteries are capable of high output at a high energy density, allowing high performance power sources, particularly power sources for on-board use in automobiles, to be built.

As noted above, the battery 100 has an electrode assembly 80 comprising a positive electrode and negative electrode, and an outer case 40 for housing the electrode assembly 80 and an electrolyte. The structure of the rolled electrode assembly housed in the outer case 40 will be described in detail.

Like the rolled electrode assembly in normal lithium ion batteries, the rolled electrode assembly in the embodiments is a rolled electrode assembly in which a positive electrode in the form of a sheet (referred to below as “positive electrode sheet”) and a negative electrode in the form of a sheet (referred to below as “negative electrode sheet”) are laminated with a total of two separators in the form of sheets (referred to below as “separator sheets”), and the positive electrode and negative electrode are rolled slight offset from each other.

As a result of being rolled slightly offset from each other as noted above in the horizontal direction relative to the direction in which the rolled electrode assembly is rolled, part of the ends of the positive electrode sheet and negative electrode sheet will protrude out of the rolled core portion (that is, the portion where the positive electrode active material layer of the positive electrode sheet is formed, the portion where the negative electrode active material layer of the negative electrode sheet is formed, and the separators are tightly rolled). On the positive electrode side, a positive electrode collector plate 85 is provided at the part that protrudes out (that is, the portion where the positive electrode active material layer is not formed), and is electrically connected to the sealing bottom plate 26 of the sealing lid 20. On the negative electrode side, the part that protrudes out (that is, the portion where the negative electrode active material layer is not formed) is electrically connected to the outer case 40 via a negative electrode side collector plate (not shown).

The materials forming the rolled electrode assembly and the parts themselves may be the same as conventional electrode assemblies in lithium ion batteries, and are not particularly limited. For example, the positive electrode sheet can be formed by applying a positive electrode active material layer for a lithium ion battery on a continuous positive electrode collector. Aluminum (these embodiments) and other metals suitable for positive electrodes are suitable for the positive electrode collector. One or more materials conventionally used for lithium ion batteries can be used without limitation as the positive electrode active material. Suitable examples include LiMn₂O₄, LiCoO₂, and LiNiO₂.

Meanwhile, the negative electrode sheet can be formed by applying a negative electrode active material layer for a lithium ion battery on a continuous negative electrode collector. Copper foil (these embodiments) and other metals suitable for negative electrodes are suitable for the negative electrode collector. One or more materials conventionally used for lithium ion batteries can be used without limitation as the negative electrode active material. Suitable examples include carbonaceous materials such as graphite carbon and amorphous carbon, and lithium-containing transition metal oxides or transition metal nitrides.

Examples of separators suitable for use between the positive and negative electrodes include those formed with porous polyolefin resins. No separator is needed when solid electrolytes or gel electrolytes are used as the electrolyte (that is, the electrolyte itself can function as a separator in such cases).

Examples of electrolytes that can be housed along with the rolled electrode assembly 80 in the outer case 40 include lithium salts such as LiPF₆. A suitable amount (such as a concentration of 1 M) of a lithium salt such as LiPF₆ can be dissolved in a non-aqueous electrolyte solution such as a diethyl carbonate and ethylene carbonate solvent mixture (such as a 1:1 volumetric ratio) for use as the electrolyte.

The rolled electrode assembly 80 and the above electrolyte are housed in the outer case 40, and the sealing lid 20 is attached to the outer case 40 and sealed thereto, with a gasket 44 in between, giving the battery 100 of the present embodiments.

The invention was illustrated above in preferred embodiments, but the invention is not limited to this description and is, of course, capable of various modifications. For example, in the above embodiments, the current cutoff valve was provided in the sealing lid, but the invention is not limited to this. For example, a current cutoff valve having the structure illustrated above and its attachment structure may be provided on the battery outer case side (main unit side).

### INDUSTRIAL APPLICABILITY

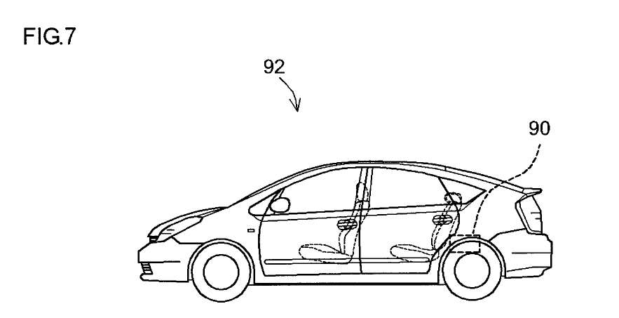

The structure of the invention makes it possible to provide a sealed battery that is capable of outputting large current while preventing the cutoff function of the current cutoff valve from being compromised. For example, because the battery 100 disclosed herein is capable of outputting large current, it is particularly suitable for use as an on-board motor power source for automobiles (electric motor). That is, as illustrated in FIG. 7, batteries provided by the invention can be arranged in a certain direction as unit cells, and the unit cells can be bundled in the arranged direction to build an assembled battery (a battery pack) 90. It is thus possible to provide a vehicle 92 equipped with the assembled battery (battery pack) 90 as the power source (typically, an automobile, especially an automobile equipped with an electric motor, such as a hybrid automobile, electrical automobile, or fuel cell automobile).

1. A sealed battery, comprising:
an electrode assembly;
an outer case housing the electrode assembly;
a sealing lid for closing an opening of the outer case; and
a current cutoff valve that is deformed by abnormal internal pressure in the outer case, wherein
a plurality of conductive members for carrying current between the current cutoff valve and electrode assembly are attached to the current cutoff valve, and
the plurality of conductive members are configured so as to be broken off in a stepwise manner by the deformation of the current cutoff valve as a result of abnormal internal pressure, thereby shutting off the current flowing between the current cutoff valve and electrode assembly.

2. The sealed battery according to claim 1, wherein the current cutoff valve is provided in the sealing lid.

3. The sealed battery according to claim 1, wherein
the plurality of conductive members are attached, with a predetermined loosening margin, to one or more connecting points on the current cutoff valve, and
the one or more connecting points are configured to shift in a direction to extend the loosening margin of the conductive members by the deformation of the current cutoff valve, and the plurality of conductive members are sequentially broken off at different points in time respectively as the connecting points shift.

4. The sealed battery according to claim 3, wherein the plurality of conductive members are attached, with varying loosening margins, to the same connecting point on the current cutoff valve.

5. The sealed battery according to claim 3, wherein the plurality of conductive members are each attached, with the same loosening margin, to different connecting points on the current cutoff valve.

6. A vehicle equipped with the sealed battery according to claim 1.

7. A vehicle equipped with the sealed battery according to claim 3.
